(19) United States
(12) Patent Application Publication
(10) Pub. No.: US 2009/0044913 A1
(43) Pub. Date: Feb. 19, 2009

(54) DEVICE AND METHOD FOR JOINTING PLASTICS MATERIALS

(75) Inventor: Michael Charles Short, Butts Ash (GB)

Correspondence Address: RISSMAN JOBSE HENDRICKS & OLIVERIO, LLP, 100 Cambridge Street, Suite 2101, BOSTON, MA, 02114, US

(73) Assignee: Polymer Welding Technologies Limited, Gillingham (GB)

(21) Appl. No.: 12/194,890

(22) Filed: Aug. 20, 2008

Related U.S. Application Data
(63) Continuation of application No. PCT/GB2007/000600, filed on Feb. 21, 2007.

(30) Foreign Application Priority Data
Feb. 21, 2006 (EP) 06250907.0

(51) Int. Cl. B32B 37/06

(52) U.S. Cl. 156/379.7

(57) ABSTRACT

A jointing strip for jointing by welding at least two portions of a plastics material or of two different plastics materials includes a substantially H-shaped plastic member with apertures defined by opposing jaw portions. Electrically conductive elements, for example foil portions, are located at or near to a surface in the apertures of the respective jaw portions. The edge portions of the plastics materials to be welded are inserted in the apertures.

### CROSS-REFERENCE TO RELATED APPLICATIONS

This application is a continuation of prior filed copending PCT International application no. PCT/GB2007/000600, filed Feb. 21, 2007, which designated the United States and has been published as International Publication No. WO 2007/096611 and on which priority is claimed under 35 U.S.C. § 120, and which claims the priority of European Patent Application, Application No. 06250907.0, filed Feb. 21, 2006, pursuant to 35 U.S.C. 119(a)-(d), the contents of which are incorporated herein by reference in their entirety as if fully set forth herein.

### FIELD OF THE INVENTION

The invention relates to the jointing of plastics materials by welding, as well as to a jointing strip for forming a welded joint and to a method of manufacturing the strip. The invention more particularly relates to a jointing strip for jointing flexible thermoplastics sheets and/or plastics foam material sheets made of long-chain molecular polymeric materials.

### BACKGROUND OF THE INVENTION

Many comparatively large flexible plastics sheet products are manufactured from smaller sheets or panels of flexible plastics material which have to be jointed together by various known methods, such as, adhesives or welding by RF heating or ultrasonic techniques, stitching or any combination thereof. However, it has been found that the known methods of manufacturing comparatively large flexible plastics sheet products, sometimes as large as several thousands of square meters in area, are slow, expensive and, in many cases, unreliable.

The failure of welds, stitching and other types of jointing between sheets or panels of plastics materials can, in some cases, be life-threatening and, in certain circumstances, it is extremely difficult both to check such welds or other types of connection for integrity and strength at the production stage and to repair them if subsequently found to be faulty. Faults are most often found in service and, in many cases, cannot be repaired unless the faulty product is taken out of commission and returned to the source of manufacture when, in certain circumstances, even repairs at that stage are impossible or not commercially viable.

A device for welding together plastics materials made two or more panels of flexible plastics sheet material has been disclosed, for example, in WO 1994/14599, which discloses a generally flat jointing strip, wherein the elongate outer member is substantially H-shaped in cross-section and defines a pair of slots in back-to-back relationship with each other. The device includes a heating element which, when an electrical current is passed therethrough, causes the jointing strip to weld to the plastics materials. In each recess of the slots is located a resistive heating component in the form of an expanded copper tape.

While this form of jointing strip has been applied successfully in jointing a large number of plastics materials, it has been found that long-chain molecular polymeric materials, such as Spectra®, Dyneema® and Kevlar®, require a better control of the heat transfer between the surfaces inside the slots and the polymeric materials to be welded.

Accordingly, there is a need to improve the joining together of sheets or panels of plastics materials, in particular long-chain molecular polymeric materials, resulting in joints which will be at least substantially as strong as the parent material. Such joints are preferably fluid tight.

### BRIEF SUMMARY OF THE INVENTION

According to one aspect of the invention, a jointing strip having two opposing jaws connected by a spine, with the jaws comprising surface portions that define a corresponding aperture therebetween. Each aperture is configured to receive a portion of plastics material to be jointed. The jointing strip further includes a plurality of electrically conductive heating elements located at or substantially proximal to the surface portions, wherein the heating elements are spaced at least across the opposing jaws. The heating elements are configured to cause, when energized with an electric current, substantially the entire surface portion of the jaws to meltplastics material.

The conductive foil strips may have substantially unvarying dimensions and may be placed substantially parallel to each other at substantially 90° to the insert slot of the jointing strip. Such an arrangement advantageously allows reduction of current used to obtain the hot melt temperature during a current cycle.

Exemplary embodiments may include one or more of the following features.

Each jaw of a jaw portion may be resiliently biased towards the other opposing jaw. The heating means may include a plurality of elongate conductive portions, the lateral dimension of each of which is directed generally towards the jaw aperture. One or more of the free ends of each of the jaws may include a radiused or rounded portion which is configured to engage with a surface of a material to be jointed. The bias between the opposing jaw may provide a seal between the inserted plastics material (sheet) and the jaws, thus retaining molten plastic between the biased jaws. The jointing strip may be used to joint two pieces of polymer material, wherein at least one piece may be a long-chain polymer material.

According to another aspect of the invention, a jointing structure may be made of a jointing strip of the aforedescribed type and two pieces of plastics material, with the jointing strip jointing the two pieces of plastics material, wherein at least one piece may be a long-chain polymer material.

These and other features and advantages of the present invention will become more readily appreciated from the detailed description of the invention that follows. Like reference numerals are used to denote like features.

### BRIEF DESCRIPTION OF THE DRAWINGS

FIG. 1 is a cross-sectional side view of a first embodiment of a jointing strip;

FIG. 2 is a cross-sectional side view of a second embodiment of a jointing strip, and;

FIG. 3 is a cross-sectional view of modified electrically resistive elements of the type generally shown in the embodiment of FIG. 1.

### DETAILED DESCRIPTION OF THE INVENTION

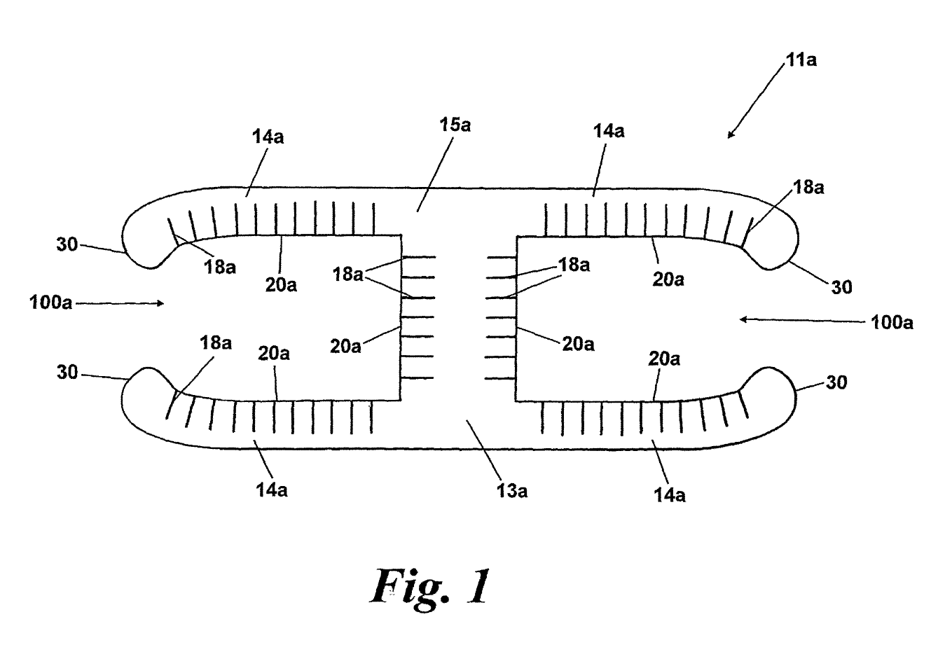

According to one exemplary embodiment of the invention shown schematically in FIG. 1, a jointing strip indicated generally as 11a includes an elongate outer member 15a which is made of a polymer material and has a generally H-shaped cross-section defining a pair of back-to-back generally U-shaped slots 100a separated by a central spine 13a. Pairs of side arms or jaws 14a of the outer member 15a which define the sides of each U-shaped slot 100a, each have inwardly turned ends 30 which can be radiused and perform a gripping and/or sealing function when a plastic sheet or foil to be welded is inserted in the slot(s), as described below.

Electrical resistance means is provided in each arm or jaw 14 by a plurality of elongate electrically conductive portions 18a (in the form of foil strips, which may advantageously be perforated so as to provide keying/anchoring means) which extend substantially the length of the strip 11a. The portions 18a are arranged parallel to one another and the lateral extent/width of each strip is orientated generally towards a respective slot of the jointing strip, and more particularly, substantially perpendicular to the depth of each slot. Spine 13a is also provided with electrically conductive portions 18a. The conductive portions are embedded into the (single) polymer material 15a of the jointing strip so as to be substantially flush with respective surface 20a (which surfaces define slots 100a). It will be appreciated, however, that the innermost edge regions of the portions 18a may be set back from the respective surfaces 20a. By positioning the conductive portions proximal to surfaces 20a, outer surfaces of an inserted polymer sheet are caused to melt. The spacing of the conductive elements is such so as to allow substantially all of each of the meltable/welding surfaces 20a to melt. This ensures a joint of optimal strength.

In an alternative embodiment, each group of portions 18a may be provided as a one-piece, integral component wherein the portions 18a are connected by bridging portions (not shown) which extend between adjacent electrically conductive portions 18a.

The free end of each arm 14a is configured to extend towards the free end of the opposed jaws in a resiliently biased manner. It will be appreciated that each jaw 14 is formed of material with some resilience. In use when a sheet of material to be jointed is inserted into a respective slot 100a, the jaws 14 act to resiliently grip the outer surfaces of the sheet. It is to be noted that the free end of each jaw 14 is in the form of a radiused or rounded portion 30a which in use bears against a respective outer surface of a sheet to be jointed. During the welding process the engagement between the radiused or rounded portions and the sheet serves a sealing function so as to enable containment of molten polymer.

At the distal ends of the strip 11a, each of the six groups of conductive portions 18a, adjacent end portions thereof are electrically connected to each other and are provided with a connection means (not illustrated) for supplying power to each group.

Although all three surfaces 20a of each side are provided with portions 18a, in alternative embodiments it may be that a surface 20a of the spine 13 is not provided with said conductive portions 18a.

Advantageously since the cross-sectional dimensions of the conductive portions 18a are substantially constant throughout the length thereof, and since the resistivity thereof is known, this enables the power requirements to be calculated accurately for the welding process.

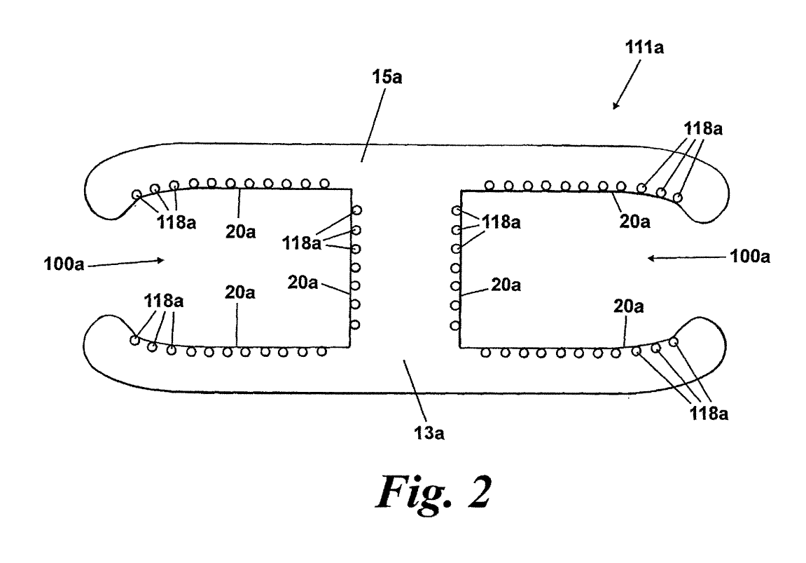

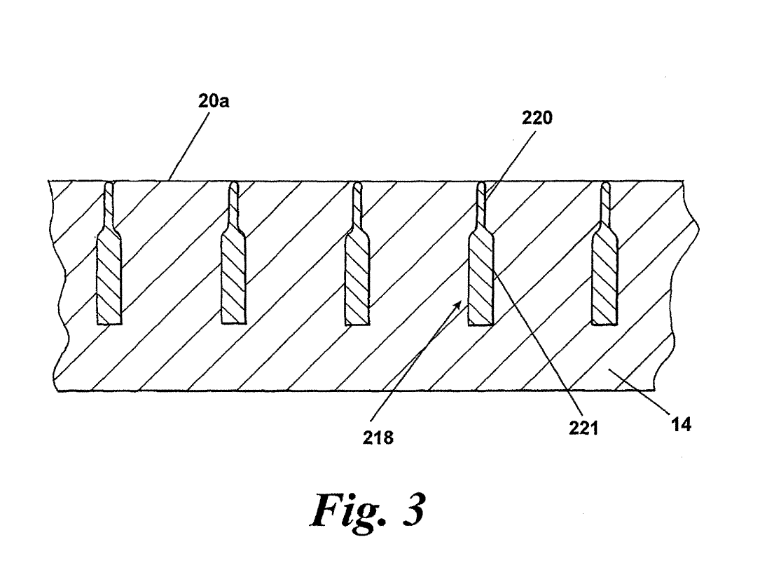

FIG. 3 shows an alternative embodiment of that shown in FIG. 1 wherein each of the conductive portions 18a is provided by metal strips 218. As can be seen from FIG. 3, each strip 218 comprises two portions 220 and 221. The portion 220 which is closest to the welding surface 20a of the jaw is narrower (and overall cross-sectional area) than that of the portion 221. This results in the portions 220 having a greater electrical resistance than the portions 221. Accordingly, most of the heat generated by each strip 218 will be generated by the portions 220, whereas the portions 221 serve to carry the current which is supplied to said portions 220. Although reference above has been made to the use of metal strips as the electrically conductive elements, different types of electrically conductive components may be employed. For example, as shown in FIG. 2, the electrically conductive foil strips may be replaced by solid wires 118a.

Alternatively hollow tubes of metallic mesh may be employed. Such tubes may be kept hollow during the manufacturing process of the jointing strip, so that adjacent tubes could be electrically connected by way of a plug-in connection.

The jointing strip may be used to connect plastic sheets made, for example, of two or more portions of a long-chain polymer material, such as Spectra®, Dyneema® and Kevlar®, to form a protective barrier assembly with at least one inflatable cell. The barrier assembly could be maintained in a stowed condition when not in use and activated into a deployed (inflated) state, to provide a protective barrier.

The assembly may be configured to be installed in a floor, wall or roof structure. The assembly may be provided as a stand-alone structure. The assembly may also be provided as a number of linking structures which may be deployed with parts inflated to provide a strong rigid framework. Each component part structure may be man-portable. Once positioned on a road or other surface in partially inflated form, the structure may be rapidly inflated to form an explosion proof trap or barrier.

The assembly may be configured to be installed into a vehicle, such as a waterborne vehicle, an airborne vehicle or a land vehicle. The assembly may be configured to be installed in an outer wall or surface of the vehicle.

The assembly may be configured to be installed onto and/or into a building. Preferably the assembly is configured to be installed to a window structure, wherein, in use, the assembly is deployed in front of and/or behind the window structure.

In use of the embodiment of jointing strip 11a, 111a, as shown in FIGS. 1 and 2, two sheets of plastics material (not illustrated) are inserted lengthwise with their respective edge portions in respective slots 100a of the strip 11a, 111a, the sides of the slots 100a being defined by the inner surfaces of respective pairs of jaws 14a.

In order to insert the edge portions of the plastics sheets into the associated slots 100a, the radiused ends 30 of the opposing arms 14a of a slot 100a are urged apart against the inherent resilience of the plastics material from which the jointing strip 11a is made. Upon such insertion, the respective pairs of ends 30 grip the edge portions of the plastics sheets, to retain them in the correct position with respect to the slots prior to and during the welding operation.

Once the edge portions of the plastics sheets have been received and positioned within the slots 100a, an electric current is passed through the conductive portions 18a, such that they, as resistive heating components, heat the surfaces 20a in the aperture of the jaw portion to a temperature which is sufficient to melt the plastics material at the surfaces 20a of the jointing strip 11a. In this manner, the surfaces 20a of the jointing strip 111a become welded to the edge portions of the plastics sheets, with the sheets being jointed together in a fluid tight manner.

While the invention is receptive to various modifications, and alternative forms, specific examples thereof have been shown in the drawings and are herein described in detail. It should be understood, however, that the invention is not limited to the particular forms or methods disclosed, but to the contrary, the invention is meant to cover all modifications, equivalents, and alternatives falling with the spirit and scope of the appended claims.

What is claimed is:

1. A jointing strip comprising:
two opposing jaws connected by a spine, each jaw comprising a surface portion, the surface portions define an aperture therebetween, said aperture configured to receive a portion of plastics material to be jointed, and
a plurality of electrically conductive heating elements located at or substantially proximal to the surface portions, the heating elements spaced at least across the opposing jaws and configured to cause, when energized with an electric current, substantially the entire surface portion of the jaws to melt.

2. The jointing strip of claim 1, wherein each jaw is resiliently biased towards an opposing jaw.

3. The jointing strip of claim 1, wherein the electrically conductive elements comprise elongate conductive portions, with a lateral dimension of each of the conductive elements directed towards the aperture.

4. The jointing strip of claim 1, wherein a free end portion of each of the jaws is rounded and configured to engage with a surface of a material to be jointed.

5. The jointing strip of claim 1, wherein at least one portion of the plastics material to be jointed comprises a long-chain polymer material.

6. The jointing strip of claim 1, wherein a plurality of electrically conductive elements is disposed at a surface of the spine facing the aperture.

7. A jointing structure comprising a jointing strip according to claim 1 and two pieces of plastics material jointed by the jointing strip.
